(19) United States
(12) Patent Application Publication
(10) Pub. No.: US 2006/0243653 A1
(43) Pub. Date: Nov. 2, 2006

(54) Dialysis filter

(76) Inventors: Bernd Heinrich, Durrrohrsdorf-Dittersbach (DE); Konrad Martins, Dresden (DE); Dieter Mehnert, Radeberg (DE); Eckard Muller, Radeberg (DE); Katrin Kracht, Dresden (DE); Horst Franke, Dresden (DE); Rainer Hector, Osnabruck (DE)

Correspondence Address: RATNERPRESTIA, P O BOX 980, VALLEY FORGE, PA, 19482-0980, US

(21) Appl. No.: 11/406,898

(22) Filed: Apr. 19, 2006

(30) Foreign Application Priority Data
Apr. 20, 2005 (EP) 05 008 649.5

(51) Int. Cl. B01D 63/02

(52) U.S. Cl. 210/321.79; 210/321.74; 210/321.88; 210/321.83; 210/500.23

(57) ABSTRACT

A device for removing substances from blood or other body fluids, comprising a bundle of semi-permeable hollow fibers, the ends of which are embedded and held in a pottant, and a tubular casing surrounding the hollow fiber bundle. At the ends of the casing, inlet and outlet pipes are connected with partitioned fluid chambers formed in the casing. Different aspects are provided to improve the flow properties, for increasing the filtering efficiency, such as varying packing density along the length of the fiber bundle, a distributor disc within a cap, apertures on the circumference of the pottant and an ordered structure of the rippling of the hollow fibers.

This application claims priority to European Application No. 05008649.5, filed Apr. 20, 2005, which is incorporated in its entirety by reference herein.

### BACKGROUND OF THE INVENTION

The invention relates to a filter device and more particularly to a dialysis filter.

Several structural shapes of dialysis filters are known, having disadvantages in various respects, each of which impairs performance during filtration.

It is the object of the invention to design a filter device of the type mentioned above such that the filtering efficiency is improved.

### SUMMARY OF THE INVENTION

According to a first aspect of the invention, an improvement in the filtering efficiency is achieved in that the packing density of the hollow fiber bundle is varied over the length of the bundle and the hollow fiber bundle is widened in particular in the inlet and/or outlet area of the dialysate, while the packing density in the middle portion of the hollow fiber bundle is higher. Hereby a radial flow of the dialysate with as few obstructions as possible is achieved in the widened portion of the bundle, so that a uniform flow distribution over the whole cross section of the bundle results. While the lower packing density leads to low flow resistance in the inlet area and, if applicable, also in the outlet area of the radial flow, in the main part of the filter the higher packing density of the hollow fibers guarantees a uniform flow around the individual hollow fibers in the longitudinal direction. Hereby, optimal substance evacuation is achieved, especially in the inlet and outlet areas, and thus the filtering efficiency is improved.

According to a second aspect of the invention, in a front-end cap of the tubular casing a disc-shaped flow distributor is provided having on the inflow side an elevation in the area of the inlet pipe, so that homogenous velocity distribution of the blood flowing into the cap results in the radial direction. Hereby, the gap width between the inside wall of the cap and the surface of the flow distributor can be adjusted so that the flow velocity in the inlet area is distributed uniformly. The flow is uniformly widened to the maximum cap diameter. In this way, too, due to optimized guiding of the flow for avoiding eddies and due to avoiding stagnation zones which promote clotting in the blood flow, the efficiency of the filter device is improved.

According to a third aspect of the invention, the dialysate is fed to the space around the hollow fibers through apertures on the circumference of the pottant. Hereby the dialysate can be fed to the farthest accessible point of the hollow fibers, resulting in optimum use of the whole free fiber length for mass transfer, so that the filtering efficiency is improved. Another advantage of this embodiment is that the production of apertures or bores in the pottant is simple from the viewpoint of production.

According to a fourth aspect of the invention, a ripple is provided in the hollow fibers, wherein individual rippled fibers or groups of rippled hollow fibers are offset in the longitudinal direction to the adjacent rippled hollow fibers of groups of fibers. Here, a ripple length of the hollow fibers which varies over several ripples can also be provided. In this way, the flow around the hollow fibers is improved by swirling, wherein due to the fiber rippling, the abutting of the hollow fibers at one another over long distances is reduced.

The individual aspects of the invention each provide an improvement in efficiency, and through the combination of these aspects a corresponding increase in the efficiency of the dialyzer is achieved. Simultaneously, through the individual aspects and in particular through a combination of these aspects, the handling of the dialyzer is improved in so far as, before initial operation, air can be reliably removed from the individual flow areas by a flushing liquid.

### BRIEF DESCRIPTION OF THE DRAWINGS

The invention is explained in more detail below with reference to the drawings, in which

FIG. 1 is a schematic longitudinal section through a dialysis filter,

FIG. 2 is a plan view of the cross section of the bundle of hollow fibers with a seal,

FIG. 3 is a cross section through a distributor element and a plan view,

FIG. 4 illustrates diverting elements in the inlet area of the fluid between the hollow fibers, and

FIG. 5 are schematic variants in the rippling of the hollow fibers in the bundle.

### DETAILED DESCRIPTION OF THE INVENTION

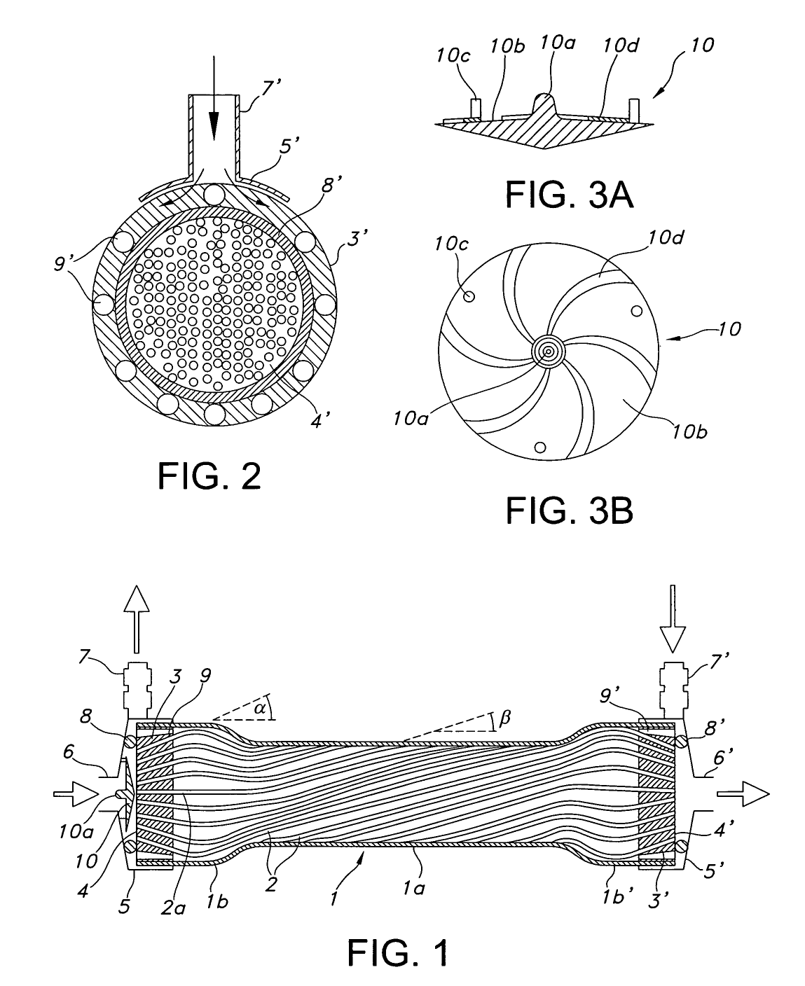

FIG. 1 shows a longitudinal section through a dialyzer having a generally tubular casing 1, which is closed at the front ends by caps 5 and 5′. In the casing 1 there is a bundle of semi-permeable hollow fibers 2 positioned through two disc-shaped blocks 3 and 3′ of a pottant, the circumference of which abuts on the inner circumference of the tubular casing 1 and in which the ends of the individual hollow fibers 2 of the bundle are liquid-impermeably embedded. The outside of the pottants 3 and 3′ each forms a flat cross section 4 or 4′ of the hollow fibers transverse to the longitudinal axis of the casing having an opening to the inside of the hollow fibers.

In the embodiment shown in FIG. 1, the section plane 4 is substantially on the level of the edge of the casing 1, wherein the caps 5 extend over the end portion of the casing 1 and are sealed in relation to the casing. However, the section plane 4 can also be arranged offset to the edge of the casing.

The caps 5 and 5′ at the casing 1 are each provided centrally with an inlet pipe 6 or an outlet pipe 6′ extending substantially in the direction of the longitudinal axis of the tubular casing 1. In a dialyzer, blood is fed through the pipe 6 and carried away by means of the pipe 6′. Dialysate is fed in counterflow through a pipe 7′ opening radially into the cap 5, and carried away through a pipe 7. The direction of flow is shown by arrows in FIG. 1.

Sealing rings 8 and 8′ extend between the cap 5, 5′ and the cross section 4, 4′, partitioning two fluid chambers in the dialyzer from one another. The first of these fluid chambers comprises the inlet pipe 6 and the outlet pipe 6′ with the central area in the caps 5 and 5′, and the inside of the hollow fibers 2; the second fluid chamber comprises the pipes 7 and 7′ for the dialysate with the flow area outside the sealing ring 8 in the caps, and the inside of the casing 1 between the individual hollow fibers 2.

Outside the sealing ring 8′, passages 9′ extending substantially axially in the pottant 3′ are arranged distributed preferably non-uniformly over the circumference, as FIG. 2 shows, and through these passages 9′ the dialysate flowing in through the inlet pipe 7′ is introduced into the second fluid chamber between the hollow fibers. In the same way, in the discharge area of the dialysate, fluid passages 9 are arranged distributed on the circumference of the pottant 3 outside the sealing ring 8.

The substantially axially extending passages 9′, which are shown in FIG. 2 as having a round cross section but which can also have a long rectangular cross section, have in the inlet area a form preferably tapering in the direction of flow, for supporting the flow distribution in the inlet area. On the discharge side, the passages 9 are formed in the same way for production reasons. In this area they can also have an identical cross-sectional shape throughout.

The passages 9′ provided on the circumference of the pottant 3′ can be formed differently regarding their spacing and/or cross section, for influencing the flow profile in particular in the inlet area. FIG. 2 shows by an arrow the dialysate flowing in through the inlet pipe 7′ in the radial direction. To prevent most of the dialysate from flowing into the fluid chamber between the hollow fibers through the passages 9′ adjacent the inlet pipe 7′ while less dialysate would flow to the diametrically opposite passages 9′, the passages 9′ are arranged more densely on the circumference on the side opposite the inlet pipe 7′ than in the area of the inlet pipe 7′. Hereby the dialysate flow into the fluid chamber around the hollow fibers is more uniformly distributed over the circumference.

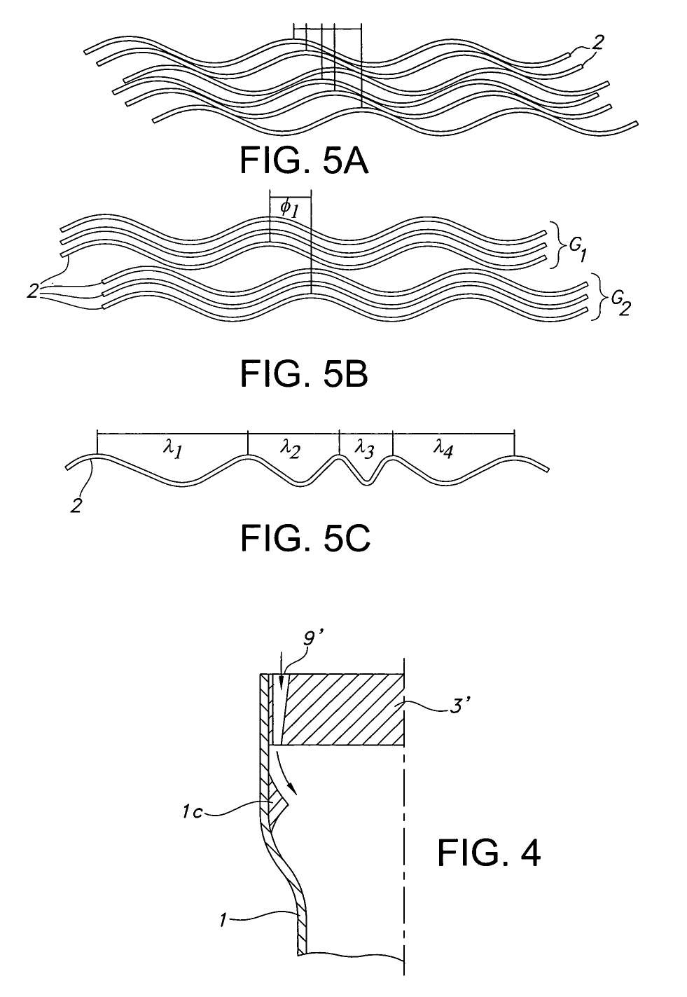

FIG. 4 shows in the inflow area of the dialysate downstream from the passages 9′ a diverting element at the inside wall of the casing 1 in the form of a projection 1c formed extending over the circumference or only adjacent the individual passages or apertures 9′, by means of which projection 1c the inflowing dialysate is guided radially inward, as shown by an arrow. This diverting element 1c can be formed onto the casing as a rib.

In the cap 5 provided with the inlet pipe 6, a disc-shaped distributor element 10 is centrally arranged transverse to the longitudinal axis. The fluid flowing in through the inlet pipe 6 approximately contacts the middle of the distributor element 10, so that the flow is uniformly distributed radially outwards from the middle. Hereby the flow uniformly flows around the outer circumference of the distributor element 10, which is at a distance from the sealing ring 8. To improve the distribution of the flow to the circumference, on the side of the fluid flowing in through the pipe 6 the distributor element 10 is provided centrally with a cone-shaped elevation 10a having a rounded front end. From the cone-shaped elevation 10a, a distributor area 10b extends to the circumferential edge of the distributor element 10. In the embodiment according to FIG. 3, the distributor area extends from the cone-shaped elevation 10a to the circumferential edge approximately at an angle of 90° to the longitudinal axis. The distributor area can also extend in a flattened cone shape from the middle outwards, so that the angle on the inflow side between the distributor area 10b and the longitudinal axis is greater than 90°. For such a flattened cone-shaped design, the cone-shaped elevation 10a can also be omitted, wherein it is replaced by the tip of the cone shape.

In such an embodiment in connection with the flattened cone shape shown in FIGS. 1 and 3, an overall somewhat disc-shaped distributor element 10 results on the underside of the distributor disc. The distributor area 10b can also be formed slightly concave, so that it extends in a curved line from a central elevation, corresponding to 10a, to the circumference.

At 10c, spacers (for example three) are shown schematically distributed over the circumference. The distributor element 10 is held by these spacers at the front end of the cap 5. The disc-shaped distributor element 10 can also be fixed in its position in the cap 5 by elevations on the upper side and/or underside, or by spoke-like elements on the circumference, wherein the cross section of these locally-provided elevations or spokes is shaped favourably for flow.

As FIG. 3b shows, the side of the distributor element 10 facing the inlet pipe 6 can advantageously also be provided with spiral-shaped ribs 10d or indentations for applying spin to the inflowing fluid. In the same way, on the side facing the cross section 4 a structuring which favours flow distribution can be provided in addition to or instead of the flattened cone-shaped form.

On the side facing the cross section 4, in the embodiment shown in FIG. 1 the distributor element 10 has a flattened cone-shaped form, wherein the tip is at a small distance from the cross section 4, so that the flow is uniformly distributed over the cross section 4 from the outside inwards, and the inflow to the individual hollow fibers 2 is promoted radially inward by the decreasing gap width.

The flow velocity between the distributor element 10 and the cross section 4 can also be influenced or uniformly formed by shaping the surface of the cross section 4 not evenly, but rather in a flattened cone-shape.

In the embodiment of FIG. 1, the wall of the cap 5 is shaped such that a gap width decreasing towards the circumference results between the distributor area 10b and the inside area of the cap 5 for forming the velocity distribution uniformly. Here, the shape of the gap is preferably shaped such that the flow velocity v of the inflowing fluid reduces more slowly radially outward than corresponding to the formula v=const./r, which would result for a constant gap width.

The gap width can thus be formed decreasing radially outward due to the cap shape and/or the shape of the distributor disc 10.

The hollow fiber bundle 2 has a packing density which varies over its length. In particular, in the inlet area at 1b the packing density is lower, seen in the axial direction, than in the middle area of the hollow fiber bundle. The packing density expressed in percent is the portion of the cross-sectional area of the bundle which is filled out by hollow fibers. In the case of round hollow fiber cross sections, the theoretical maximum attainable packing density is 90.7%. Packing densities realized in practice are in the range of 40 to 60%. Preferably, the packing density in the inlet area is approximately 30% to 40%, preferably 35% and in the middle area of the hollow fiber bundle approximately 45 to 55%, preferably 50%.

In the widened area, the hollow fiber bundle has a packing density which is smaller by at least 5, preferably 10, than the packing density in the middle area given in percent, so that, for example, for a packing density of 50% in the middle area, the packing density in the widened area is 40%, or at most 45%.

Due to the lower packing density in the inlet area of the dialysate, an improved radial flow between the hollow fibers results. Hereby, it is achieved that, in the inlet area, the dialysate already comes completely into contact with the filter areas of the hollow fibers, and thus the length of the hollow fibers is fully exploited with regard to the filtering effect. In the adjacent denser area, a flow in the longitudinal direction results, with uniform flow around the individual fibers and without the formation of passages between the hollow fibers.

As FIG. 1 shows, the ends of the hollow fibers 2 embedded in the pottant 3 are arranged such that inside the pottant 3 in the direction of the cross section 4, a higher packing density results than in the area of lowest packing density adjacent the inside of the pottant 3. In other words, above all the radially outer hollow fibers in the area of the pottant 3 extend tranverse to the longitudinal axis of the dialysis filter, so that they are packed more densely at the cross section 4 inside the sealing ring 8, and they widen out on the opposite side of the pottant 3 up to near the outer circumference of the pottant 3. The bundle diameter is thus smaller at the cross section 4 and already starts increasing in the area of the pottant.

In FIG. 1, an angle α is shown which shows the angle of inclination for example of the radially outer hollow fiber to the longitudinal axis, wherein this hollow fiber extends in the direction of the longitudinal axis, that is in a view rotated by 90° on the longitudinal axis.

A higher packing density in particular in the middle area of the hollow fiber bundle 2 can also be achieved by different degrees of twisting of the hollow fibers over their length. Here, the in itself round cross sectional shape of the fibers becomes an oval cross section perpendicular to the longitudinal axis. FIG. 1 shows, seen in the longitudinal direction, in the middle area of the hollow fiber bundle 2 a twisting of the hollow fibers around the longitudinal axis. In other words, the individual hollow fibers extend in the end portion substantially untwisted toward the pottant, wherein they substantially extend along the longitudinal axis, while in the middle area they are twisted or more powerfully twisted, wherein they form an angle β to the longitudinal axis. This becomes clear, for example, in the schematic representation in FIG. 1 at the hollow fiber 2a in the middle of the inflow area, which hollow fiber 2a extends in the inflow area substantially along the longitudinal axis, whereupon in the middle area it assumes an inclined extension to the longitudinal axis and extends around this, so that it opens out in the circumferential area of the pottant 3′ on the side not shown in the drawing. In the discharge area, this hollow fiber has a radial distance from the longitudinal axis, wherein it substantially extends in the direction of the longitudinal axis at an angle thereto.

According to an advantageous embodiment, the casing 1 is formed such that it adapts itself to the different packing density of the hollow fiber bundle 2. The casing 1 is therefore constricted in the middle area 1a seen in the longitudinal direction, so that it surrounds the hollow fiber bundle 2 in the denser packing area, while the casing 1 widens outward in a bell shape or cone shape in the end portions 1b and 1b′. Here, in the end portions 1b and 1b′ having a greater diameter, the inside wall of the casing can have a radial distance from the outer hollow fibers, as shown in FIG. 1.

The outlet area of the hollow fiber bundle 2 is preferably also provided with a lower packing density corresponding to the embodiment in the inflow area. Hereby, too, an improved radial flow to the outlet openings or passages 9′ in the pottant 3′ is achieved.

The hollow fibers preferably abut locally on the casing wall in all the areas of varying packing density, wherein such a complete filling-out of the casing cross section in the area of different casing diameter can be achieved by the mechanical residual stresses of rippled hollow fibers. Due to the mechanical residual stress of rippled hollow fibers, these splay apart and abut on the inside wall of the casing.

The widening of the hollow fiber bundle 2 is expediently formed bell- or cone-shaped, so that the dialysate flows first radially and then in the axial direction along the length of the hollow fibers.

To improve the contact of the dialysate flow with the hollow fibers, the hollow fibers are rippled along their length and preferably arranged overall twisted, at least in the middle portion 1a of the casing, as FIG. 1 schematically shows. The rippled shape of the individual hollow fibers or groups of hollow fibers is shown schematically in FIG. 5, wherein different shapes of the ripples are shown. By means of the rippling of the hollow fibers it is achieved, on the one side, that the hollow fibers abut on one another only at single positions and thus their maximum surface is available for the filtering effect, and on the other side, that due to swirling of the flow around the hollow fibers, the mass transfer is improved. Further, the fiber rippling prevents the formation of passages between the hollow fibers, that is, areas of lower packing density, through which the dialysate preferentially flows without contributing to the filtering efficiency.

FIG. 5a shows single hollow fibers 2 having approximately the same ripple length, wherein the ripples are arranged in the longitudinal direction offset from one another, corresponding to a phase offset.

FIG. 5b shows two groups G₁ and G₂, each having three rippled hollow fibers, wherein the hollow fibers extend within a group G in the same phase offset, while the adjacent group has a phase offset designated φ₁. Preferably 2 to 20, most preferably 8 hollow fibers, form a group. In at least one determined quantity of fiber groups G, one group has a predetermined phase offset to the adjacent group. Hereby an ordered structure of the arrangement of the rippled hollow fibers results within a bundle. Between hollow fibers lying parallel to one another or for rippled hollow fibers lying adjacent one another and having the same phase offset, as is the case within a group G, the dialysate flow extends along the hollow fibers without this flow pattern being changed. Due to the offset rippling of adjacent hollow fibers or adjacent hollow fiber groups G, this flow pattern is interrupted or a swirling of the dialysate flow around the hollow fibers occurs, by which the filtering efficiency is improved.

For the production of a hollow fiber bundle, preferably a predetermined quantity of groups G is formed having a predetermined offset φ₁ of the rippling relative to one another, wherein the whole bundle is composed of a plurality of such quantities. In this way, it is achieved that the single fiber groups have the predetermined phase offset at least in the area of a quantity, and thus optimal flow around the groups of hollow fibers is achieved.

FIG. 5c shows a single hollow fiber 2 having rippling varying along its length, wherein different ripple lengths λ1 to λ3 are shown.

According to another embodiment, the ripple length of the fiber rippling can change periodically with a period which is at least twice as long as the longest ripple length.

The different aspects of the invention can be combined with one another, as for example the embodiment in FIG. 1 shows. In particular, subclaims of the individual independent claims can be combined with other independent claims.

What is claimed:

1. A device for removing substances from blood or other body fluids, comprising:
a bundle of semi-permeable hollow fibers, the ends of which are embedded and held in a pottant; and
a tubular casing surrounding the hollow fiber bundle,
wherein at the ends of the casing, inlet and outlet pipes are connected with partitioned fluid chambers formed in the casing, and
the hollow fiber bundle has a packing density which is varied over its length such that, at least in an inflow portion of the fluid chamber surrounding the hollow fibers, the hollow fiber bundle has a lower packing density than in an adjacent middle portion.

2. Filter device according to claim 1, wherein in an outflow portion of the fluid chamber surrounding the hollow fibers, substantially the same packing density is provided as in the inflow portion.

3. Filter device according to claim 1, wherein in the area of the fiber ends embedded in the pottant, the packing density is higher than in the areas of lowest packing density abutting on the pottant.

4. Filter device according to claim 1, wherein the packing density varying in the longitudinal direction of the hollow fiber bundle is achieved at least partly by a different degree of twist of the hollow fibers in the different portions.

5. Filter device according to claim 1, wherein the hollow fibers have a ripple-shaped structure and abut on the casing wall over the length of the bundle at least in places in the end portions and middle portion.

6. A device for removing substances from blood or other body fluids, comprising:
a bundle of semi-permeable hollow fibers,
the ends of which are embedded and held in a pottant;
a tubular casing surrounding the hollow fiber bundle, wherein at the ends of the casing, inlet and outlet pipes are connected with partitioned fluid chambers formed in the casing; and
a disc-shaped distributor element is arranged transverse to the casing axis inside a cap on the front end of the casing, such that liquid can flow around the distributor element on both sides, wherein the inlet pipe for fluid is substantially oriented towards an elevation arranged in the middle of the distributor element, by which a uniform flow, starting from the middle, is achieved radially to the circumference.

7. Filter device according to claim 6, wherein the distributor element has a cone-shaped projection in a contact point of the inlet pipe for radially distributing the flow.

8. Filter device according to claim 7, wherein a distributor element is provided on both front ends of the casing.

9. Filter device according to claim 7, wherein the disc-shaped distributor element has elevations projecting in the axial direction serving for fixation in the cap and/or at the pottant.

10. Filter device according to claim 6, wherein the distributor element has a spiral-shaped structure on the inflow side and/or on the side opposite the pottant.

11. Filter device according to claim 6, wherein the distributor element has a flattened cone-shaped form on both sides or on the side facing the pottant.

12. Filter device according to one claim 6, wherein the gap width between the inside area of the cap and the distributor element on the side facing the inlet pipe decreases radially outward such that the flow velocity v radially outward decreases more slowly than corresponding to the formula v=const./r.

13. Filter device according to claim 6, wherein the distributor element forms a gap width with the cross section on the downstream side, which gap width decreases from radially outward inwards.

14. Filter device according to claim 6, wherein the disc has radially projecting elements on its circumference of at least one side for fixing the disc.

15. A device for removing substances from blood or other body fluids, comprising:
bundle of semi-permeable hollow fibers, the ends of which are embedded and held in a pottant; and
a tubular casing surrounding the hollow fiber bundle,
wherein at the ends of the casing, inlet and outlet pipes are connected with partitioned fluid chambers formed in the casing, and the pottant is provided on its circumference with substantially axially extending apertures or passages through which fluid is guided into the fluid chamber surrounding the hollow fibers.

16. Filter device according to claim 15, wherein the passages on an inflow side have a cross section which narrows in the flow direction.

17. Filter device according to claim 15, wherein the fluid chambers are separated from one another by an elastic sealing element bearing on the pottant.

18. Filter device according to claim 17, wherein the distance and/or the cross section of the passages is designed differently for influencing the flow profile.

19. Filter device according to claim 1, wherein the hollow fibers are rippled along their length and the ripple shapes of adjacent hollow fibers or adjacent groups of hollow fibers are arranged offset from one another in the longitudinal direction.

20. Filter device according to claim 19, wherein within a predetermined quantity of groups, the individual groups have a predetermined phase offset (φ₁) relative to one another, and the bundle is composed of a plurality of such quantities of groups.

21. Filter device according to claim 19, wherein the ripple length varies over the length of the hollow fibers.

22. Filter device according to claim 19, wherein the ripple length of the fiber rippling changes periodically by a period which is at least twice as long as the longest ripple length.

23. Filter device according to claim 19, wherein hollow fibers having ripples of differing lengths are combined into one bundle.
